(19) United States
(12) Patent Application Publication
(10) Pub. No.: US 2018/0349445 A1
(43) Pub. Date: Dec. 6, 2018

(54) PRIORITIZING DATA INGESTION SERVICES

(71) Applicant: General Electric Company, Schenectady, NY (US)

(72) Inventors: Luis Ramos, Livermore, CA (US); Ramana Venkatesh Sivasubramanian, Pleasanton, CA (US); Sriramakrishna Yelisetti, San Ramon, CA (US)

(21) Appl. No.: 15/610,307

(22) Filed: May 31, 2017

(51) Int. Cl. G06F 17/30

(52) U.S. Cl. CPC G06F 17/30528; G06Q 10/10; G06F 17/30864

(57) ABSTRACT

Methods, systems, and apparatus for prioritizing data are disclosed. A data container is parsed to obtain header information and an asset type is identified based on the header information. A weighted asset priority value and a second weighted priority value are determined. A priority level of the data container is determined based on the weighted asset priority value and the second weighted priority value. An identifier of the data container is appended to a priority queue corresponding to the determined priority level.

### TECHNICAL FIELD

This application relates generally to prioritizing data for processing. More particularly, this application relates to prioritizing data received from a variety of data sources in a cloud environment.

### BACKGROUND

The traditional Internet of Things (IoT) involves the connection of various consumer devices, such as coffee pots and alarm clocks, to the Internet to allow for various levels of control and automation of those devices. The Industrial Internet of Things (IIoT), on the other hand, involves connecting industrial assets as opposed to consumer devices. There are technical challenges involved in interconnecting diverse industrial assets, such as wind turbines, jet engines, and locomotives, that simply do not exist in the realm of consumer devices. Prioritizing the ingestion of data generated by such assets is an important aspect of connecting and managing industrial assets in an Industrial Internet environment.

### BRIEF DESCRIPTION OF DRAWINGS

The present disclosure is illustrated by way of example and not limitation in the figures of the accompanying drawings, in which like references indicate similar elements and in which:

FIG. 1 is a block diagram illustrating a system implementing an IIoT, in accordance with an example embodiment.

FIG. 2 is a block diagram illustrating different edge connectivity options that an IIoT machine provides, in accordance with an example embodiment.

FIG. 3A-3C are representations of a data container for transporting and storing IIoT data, in accordance with an example embodiment.

FIG. 3D illustrates an example technique for performing cipher block chaining (CBC) mode encryption, in accordance with an example embodiment.

FIG. 4 is an example priority table for determining a priority level for an incoming data container, in accordance with an example embodiment.

FIG. 5 is a block diagram of a portion of the example system of FIG. 1 for ingesting and processing data containers, in accordance with an example embodiment.

FIG. 6 is a block diagram of an example apparatus for ingesting, prioritizing, and processing the data containers, in accordance with an example embodiment.

FIG. 7 is a flowchart for an example method for prioritizing data to be ingested, in accordance with an example embodiment.

FIG. 8 is a block diagram illustrating a representative software architecture, which may be used in conjunction with various hardware architectures herein described.

FIG. 9 is a block diagram illustrating components of a machine, according to some example embodiments, able to read instructions from a machine-readable medium (e.g., a machine-readable storage medium) and perform any one or more of the methodologies discussed herein.

### DETAILED DESCRIPTION

The description that follows includes illustrative systems, methods, techniques, instruction sequences, and machine-readable media (e.g., computing machine program products) that embody illustrative embodiments. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques have not been shown in detail.

In an example embodiment, data is received by a variety of data sources, such as sensors, machines, and the like, interconnected in the IIoT. The data may be packaged, for example, in a data container that contains the data to be transported and stored. A signature that is generated, for example, by applying a hash function to the data content of the data container may also be included in the data container. The signature may be used to verify the integrity of the data content.

In addition to the signature, the data container may comprise other metadata associated with the data content of the container. For example, a component identifier may be added to the data container by each component traversed by the data container in a network of components (the IIoT); the component identifiers may be used to verify the path of components that the data container passed through. The data container may be stored with the signature, the component identifiers, or both to enable verification of the integrity of the data when the data is accessed in the future. In one example embodiment, the data content, data container, or both are encrypted to prevent the data from being read by an unauthorized user, unauthorized component, and the like. In one embodiment, Transport Layer Security is utilized for transmission of the data container.

The data received from the data sources may be queued for ingestion and processing, and is thus subject to varying delays during transport and processing depending, for example, on the amount of data being received, the resources available for transport, ingestion, processing, and the like. Some of the data being ingested may be of higher priority than other data and may have constraints on the amount of delay that can be tolerated. In other cases, users may request that certain data be ingested and processed at a specific priority level, such as a high priority level. Other situations may also influence the need to ingest particular data at a particular priority level. In one example embodiment, the incoming data is prioritized according to a number of parameters and assigned to an ingestion queue having a matching priority level. The ingestion queues may be statically defined or may be dynamically configured based on the state of the system. The prioritization may be performed based on data type, asset type, asset identification, a tag in the data container, user designation or request, anomaly detection, user hints, user query patterns, historical priority level, and the like.

The data priority may be based on a variety of parameters. A data type may be assigned a priority level, an asset (such as a sensor, machine, or other data source) may be assigned a priority level, and the like. For example, performance data from a wind turbine sensor may be assigned a first priority level, maintenance data from the wind turbine sensor may be assigned a second priority level, and the like. The priority level may be obtained from a centralized database, the asset, the data container, metadata associated with the data container, and the like. In one example embodiment, the asset inserts a tag in the data container that indicates the priority level of the data.

In one example embodiment, a user may designate or may request that a specified priority level be assigned to an asset, a data type, a data container, and the like (known as a hint herein). In one example embodiment, anomalies may be detected using historical data, machine learning, and the like. For example, if a sensor of an asset normally provides a sensor value of one, but provides a sensor value of five in a particular data container 300, the change in value may be considered an anomaly and may be used to increase the priority level of the data container 300.

In one example embodiment, the relevance of the data container 300 to a query or pattern of queries submitted by a user may be determined and used to prioritize the data container 300. For example, if the data container 300 contains data from a wind turbine and the query is related to a wind turbine, the data container 300 may be assigned a high priority. In one example embodiment, the priority level(s) determined for previously received data containers 300 associated with a particular asset type may be used to prioritize a newly received data container 300 associated with the same asset type. In this case, the data container 300 is weighted toward the priority level selected for the previously received data containers 300 associated with the same asset type.

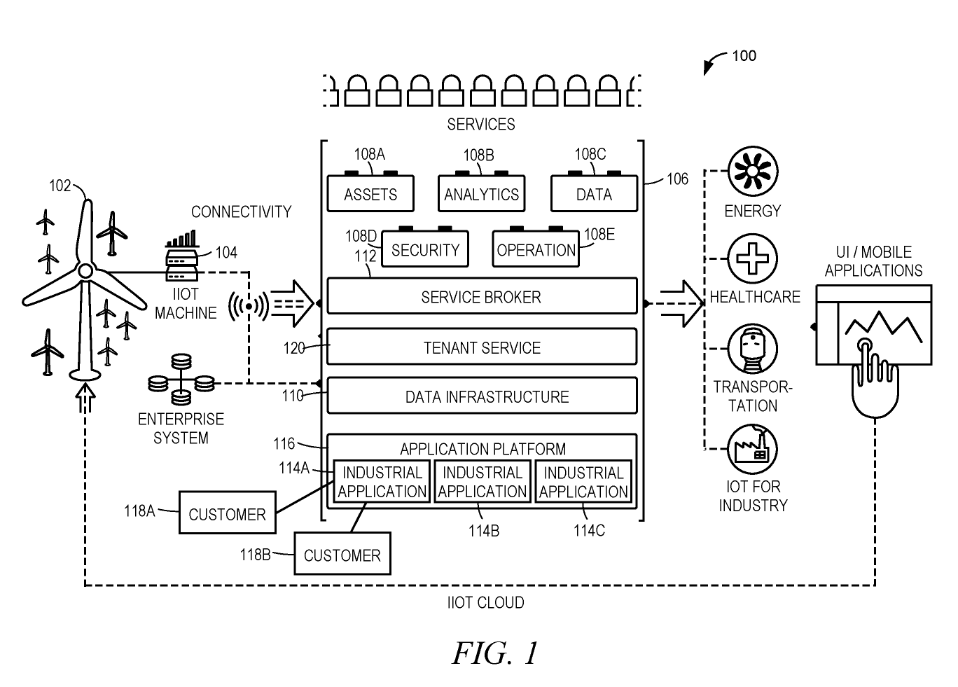

FIG. 1 is a block diagram illustrating a system 100 implementing an IIoT, in accordance with an example embodiment. An industrial asset 102, such as a wind turbine as depicted here, may be directly connected to an IIoT machine 104. The IIoT machine 104 includes a software stack that can be embedded into hardware devices such as industrial control systems or network gateways. The software stack may include its own software development kit (SDK). The SDK includes functions that enable developers to leverage the core features described below.

One responsibility of the IIoT machine 104 is to provide secure, bi-directional cloud connectivity to, and management of, industrial assets, while also enabling applications (analytical and operational services) at the edge of the IIoT. The latter permits the delivery of near-real-time processing in controlled environments. Thus, the IIoT machine 104 connects to an IIoT cloud 106, which includes various modules, including asset module 108A, analytics module 108B, data module 108C, security module 108D, and operations module 108E, as well as data infrastructure 110. This allows other computing devices, such as client computers, running user interfaces/mobile applications to perform various analyses of either the individual industrial asset 102 or assets of the same type.

The IIoT machine 104 also provides security, authentication, and governance services for endpoint devices. This allows security profiles to be audited and managed centrally across devices, ensuring that assets are connected, controlled, and managed in a safe and secure manner, and that critical data is protected.

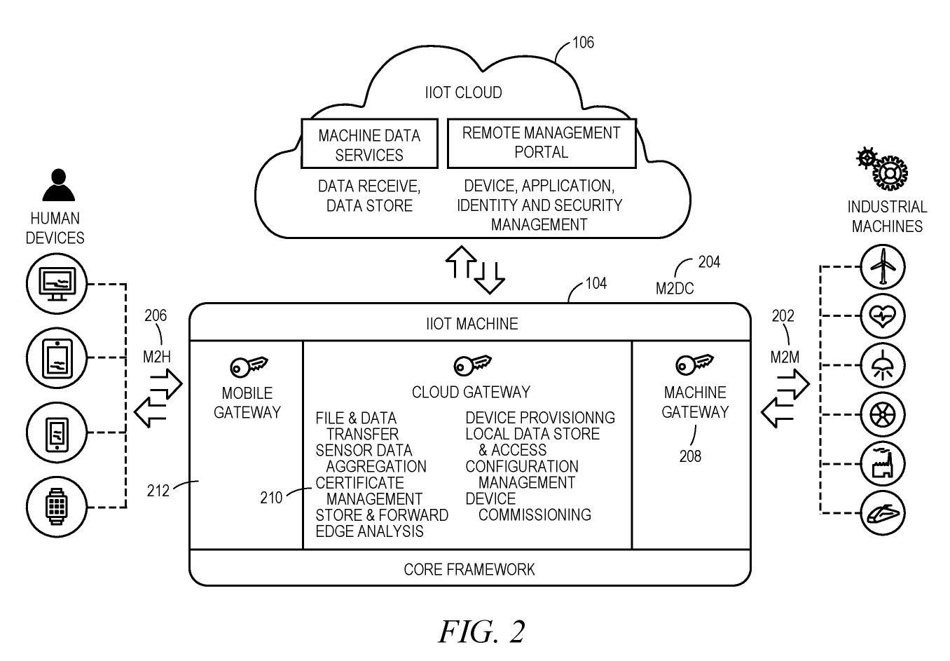

In order to meet requirements for industrial connectivity, the IIoT machine 104 can support gateway solutions that connect multiple edge components via various industry standard protocols. FIG. 2 is a block diagram illustrating different edge connectivity options that an IIoT machine 104 provides, in accordance with an example embodiment. There are generally three types of edge connectivity options that an IIoT machine 104 provides: machine gateway (M2M) 202, cloud gateway (M2DC) 204, and mobile gateway (M2H) 206.

Many assets may already support connectivity through industrial protocols such as Open Platform Communication (OPC)-UA or ModBus. A machine gateway component 208 may provide an extensible plug-in framework that enables connectivity to assets via M2M 202 based on these common industrial protocols.

A cloud gateway component 210 connects an IIoT machine 104 to an IIoT cloud 106 via M2DC.

A mobile gateway component 212 enables people to bypass the IIoT cloud 106 and establish a direct connection to an asset 102. This may be especially important for maintenance scenarios. When service technicians are deployed to maintain or repair machines, they can connect directly from their machine to understand the asset's operating conditions and perform troubleshooting. In certain industrial environments where connectivity can be challenging, the ability to bypass the cloud and create this direct connection to the asset may be critical.

As described briefly above, there are a series of core capabilities provided by the IIoT system 100. Industrial scale data, which can be massive and is often generated continuously, cannot always be efficiently transferred to the cloud for processing, unlike data from consumer devices. Edge analytics provide a way to preprocess the data so that only the pertinent information is sent to the cloud. Various core capabilities provided include file and data transfer, store and forward, local data store and access, sensor data aggregation, edge analytics, certificate management, device provisioning, device decommissioning, and configuration management.

As described briefly above, the IIoT machine 104 can be deployed in various different ways, including on the gateway, on controllers, or on sensor nodes. The gateway acts as a smart conduit between the IIoT cloud 106 and the asset(s) 102. The IIoT machine 104 may be deployed on the gateway device to provide connectivity to asset(s) 102 via a variety of protocols.

The IIoT machine 104 can be deployed directly onto machine controller units. This decouples the machine software from the machine hardware, allowing connectivity, upgradability, cross-compatibility, remote access, and remote control. It also enables industrial and commercial assets that have traditionally operated standalone or in very isolated networks to be connected directly to the IIoT cloud 106 for data collection and live analytics.

The IIoT machine 104 can be deployed on sensor nodes. In this scenario, the intelligence lives in the IIoT cloud 106 and simple, low-cost sensors can be deployed on or near the asset(s) 102. The sensors collect machine and environmental data and then backhaul this data to the IIoT cloud 106 (directly or through an IIoT gateway), where it is stored, analyzed, and visualized.

Customers or other users may create applications to operate in the IIoT cloud 106. While the applications reside in the IIoT cloud 106, they may rely partially on the local IIoT machines 104 to provide the capabilities to gather sensor data, process it locally, and then push it to the IIoT cloud 106.

The IIoT cloud 106 enables the IIoT by providing a scalable cloud infrastructure that serves as a basis for platform-as-a-service (PaaS), which is what developers use to create Industrial Internet applications for use in the IIoT cloud.

Referring back to FIG. 1, services provided by the IIoT cloud and generally available to applications designed by developers include asset services from asset module 108A, analytics services from analytics module 108B, data services from data module 108C, application security services from security module 108D, and operational services from operations module 108E.

Asset services include services to create, import, and organize asset models and their associated business rules. Data services include services to ingest, clean, merge, and ultimately store data in the appropriate storage technology so that it can be made available to applications in the manner most suitable to their use case.

Analytics services include services to create, catalog, and orchestrate analytics that will serve as the basis for applications to create insights about industrial assets. Application security services include services to meet end-to-end security requirements, including those related to authentication and authorization.

Operational services enable application developers to manage the lifecycle and commercialization of their applications. Operational services may include development operational services, which are services to develop and deploy Industrial Internet applications in the cloud, as well as business operational services, which are services that enable transparency into the usage of Industrial Internet applications so that developers can ensure profitability.

The asset model may be the centerpiece of many, if not all, Industrial Internet applications. While assets are the instantiations of asset types (types of industrial equipment, such as turbines), the asset model is a digital representation of the asset's structure. In an example embodiment, the asset service provides Application Program Interfaces (APIs), such as Representational State Transfer (REST) APIs that enable application developers to create and store asset models that define asset properties, as well as relationships between assets and other modeling elements. Application developers can then leverage the service to store asset-instance data. For example, an application developer can create an asset model that describes the logical component structure of all turbines in a wind farm and then create instances of that model to represent each individual turbine. Developers can also create custom modeling objects to meet their own unique domain needs.

In an example embodiment, the asset module 108A may include an API layer, a query engine, and a graph database. The API layer acts to translate data for storage and query in the graph database. The query engine enables developers to use a standardized language, such as Graph Expression Language (GEL), to retrieve data about any object or property of any object in the asset service data store. The graph database stores the data.

An asset model represents the information that application developers store about assets, how assets are organized, and how assets are related. Application developers can use the asset module 108A APIs to define a consistent asset model and a hierarchical structure for the data. Each piece of physical equipment may then be represented by an asset instance. Assets can be organized by classification and by any number of custom modeling objects. For example, an organization can use a location object to store data about where its pumps are manufactured, and then use a manufacturer object to store data about specific pump suppliers. It can also use several classifications of pumps to define pump types, assign multiple attributes, such as Brass or Steel, to each classification, and associate multiple meters, such as Flow or Pressure, to a classification.

The application security services provided by the security module 108D include user account and authentication (UAA) and access control. The UAA service provides a mechanism for applications to authenticate users by setting up a UAA zone. An application developer can bind the application to the UAA service and then use services, such as basic login and logout support for the application, without needing to recode these services for each application. Access control may be provided as a policy-driven authorization service that enables applications to create access restrictions to resources based on a number of criteria.

Thus, a situation arises where application developers wishing to create industrial applications for use in the IIoT may wish to use common services that many such industrial applications may use, such as a log-in page, time series management, data storage, and the like. The way a developer can utilize such services is by instantiating instances of the services and then having their applications consume those instances. Typically, many services may be so instantiated.

Data services from the data module 108C enable Industrial Internet application developers to bring data into the system and make it available for their applications. This data may be ingested via an ingestion pipeline that allows for the data to be cleansed, merged with data from other data sources, prioritized, and stored in the appropriate type of data store, whether it be a time series data store for sensor data, a Binary Large Object (BLOB) store for medical images, or a relational database management system (RDBMS).

Since many of the assets are industrial in nature, much of the data that will commonly be brought into the IIoT system 100 for analysis is sensor data from industrial assets. In an example embodiment, a time series service may provide a query efficient columnar storage format optimized for time series data. As the continuous stream of information flows from sensors and needs to be analyzed based on the time aspect, the arrival time of each stream can be maintained and indexed in this storage format for faster queries. The time series service also may provide the ability to efficiently ingest massive amounts of data based on extensible data models. The time series service capabilities address operational challenges posed by the volume, velocity, and variety of IIoT data, such as efficient storage of time series data, indexing of data for quick retrieval, high availability, horizontal scalability, and data point precision.

Applications 114A-114C, which are created by a developer and may be run on the cloud, may be hosted by application platform 116. Customers 118A-118B may then interact with applications 114A-114C to which they have subscribed. Here, for illustrative purposes, customers 118A and 118B are both tenants of application 114A. A tenant service 120 may be used to manage tenant-related modifications, such as management of templates and creation of tenants.

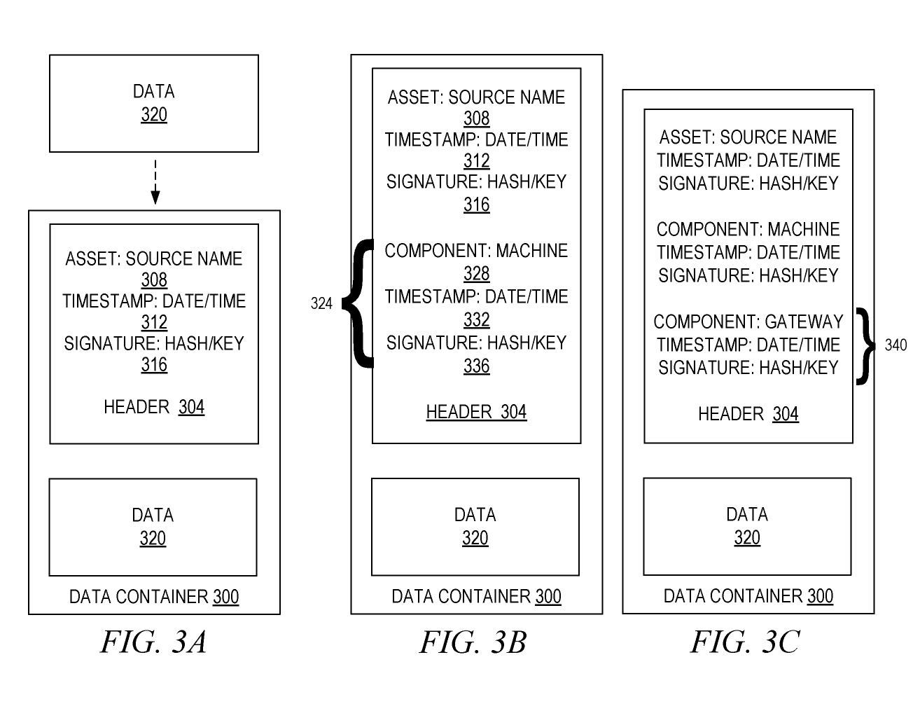

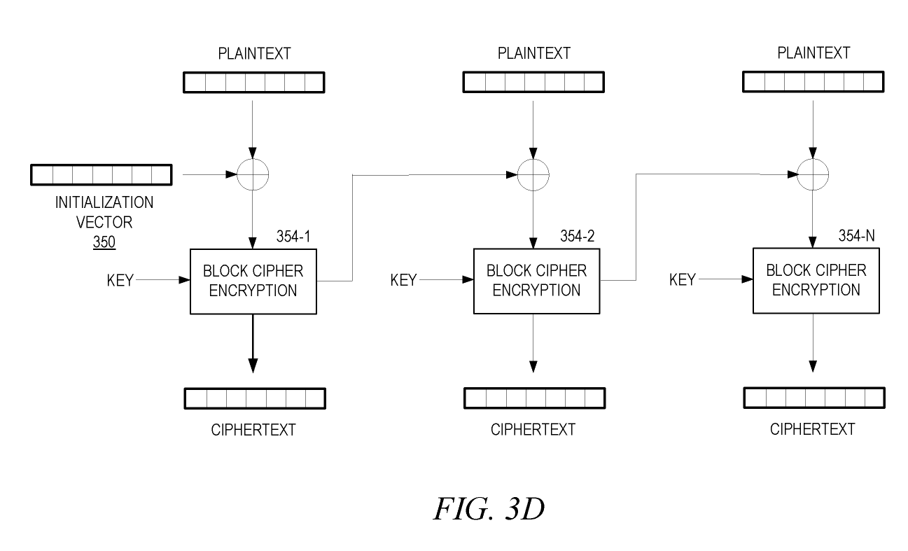

FIG. 3A-3C are representations of a data container 300 for transporting and storing IIoT data 320, in accordance with an example embodiment. The data 320 may be produced by a sensor, generated by the IIoT machine 104, and the like. In order to ensure that data 320 is not maliciously or erroneously changed, a watermark, such as a signature 316, is added to the data container 300. In one example embodiment, the signature 316 is added to the data container 300 without changing the data content of the container. The signature 316 is generated, for example, by applying a hash function to the data content (i.e., data 320) of the data container 300. The signature 316 may be generated using a key in addition to the data 320. In one example embodiment, the signatures and keys are based on pretty good privacy (PGP) and GNU privacy guard (gpg) block ciphers. The signature 316 may be used to verify the integrity of the data 320 as the data container 300 traverses components within the IIoT and after retrieval of the data container 300 from a storage component. In one example embodiment, there is an asset bootstrap process to enable the key store to obtain the key; a key chain is maintained to give to the components, including assets and cloud components.

As illustrated in FIG. 3A, the data 320 is wrapped in the data container 300 prior to transport. The data container 300 includes a header 304 that contains metadata associated with the data container 300. The header 304 includes the signature 316 and a source identifier 308 that identifies the source of the data 320, such as the name of the sensor that produced the data 320. The header 304 may also contain a timestamp 312 indicating the time that the data 320 was produced or the time that the data container 300 was created.

As the data container 300 traverses components of the IIoT, such as the IIoT machine 104, the machine gateway (M2M) 202, and the like, a component section 324 may be added to the header 304 for each traversed component. As illustrated in FIG. 3B, the component section 324 may include a component identifier 328 that identifies the corresponding component, an optional timestamp 332 that indicates the time the data 320 (or the data container 300) was modified by the corresponding component, a component signature 336, or any combination thereof. The component signature 336 may be a copy of the signature 316, may be generated by applying a hash function to the data 320 (as modified, supplemented, or both by the component), or may be generated by applying a hash function to the original data 320. The signature 336 may also be generated using a hash function and a key. As illustrated in FIG. 3C, additional component sections, such as component section 340, may be added to the header 304 as the data container 300 traverses additional components of the IIoT.

In one example embodiment, the data 320 from a sensor, such as a sensor measuring the power generated by a wind turbine, is collected by, for example, the IIoT machine 104. The IIoT machine 104 wraps the data 320 in a data container 300 and adds the source identifier 308, the timestamp 312, and the signature 316 to the data container 300. The data container 300 is transferred from the IIoT machine 104 to, for example, the machine gateway (M2M) 202. In one example embodiment, the data container 300 is transferred from the IIoT machine 104 directly to a data collector and then to the machine gateway (M2M) 202. In either case, the data collector, the machine gateway (M2M) 202, or both may add a component section 324 to the header 304 of the data container 300.

In one example embodiment, components that receive the data 320 obtained from the data container 300 may verify the source signature 316, the component signature(s) 336, or both. For example, an analytics component may perform an on-the-fly (in-flight) analysis of the data 320. In addition, a stored data container 300 may be retrieved to perform post-flight analysis in order to generate, for example, historic analytics. A component that receives the data container 300 may also verify the path of components traversed by the data container 300.

FIG. 3D illustrates an example technique for performing CBC mode encryption, in accordance with an example embodiment. In general, a signature is generated on a hash of the data using a key and may be generated based on the CBC mode encryption of FIG. 3D. In the example of FIG. 3D, the function may be defined by the equation:

Eₖ(P):=E(K,P): {0,1}^{k}×{0,1}ⁿ→{0,1}ⁿ

For any block cipher and key, the function Eₖ is to be a bijective function.

An initialization vector 350 is a cryptographic primitive of a specified length. In one example embodiment, the value(s) and length of the initialization vector 350 are random or pseudorandom. Each block cipher encryption unit 354-1, . . . , 354-N encrypts a fixed-length group of bits, called a block, using a deterministic algorithm. A key specifies an unvarying transformation of the data.

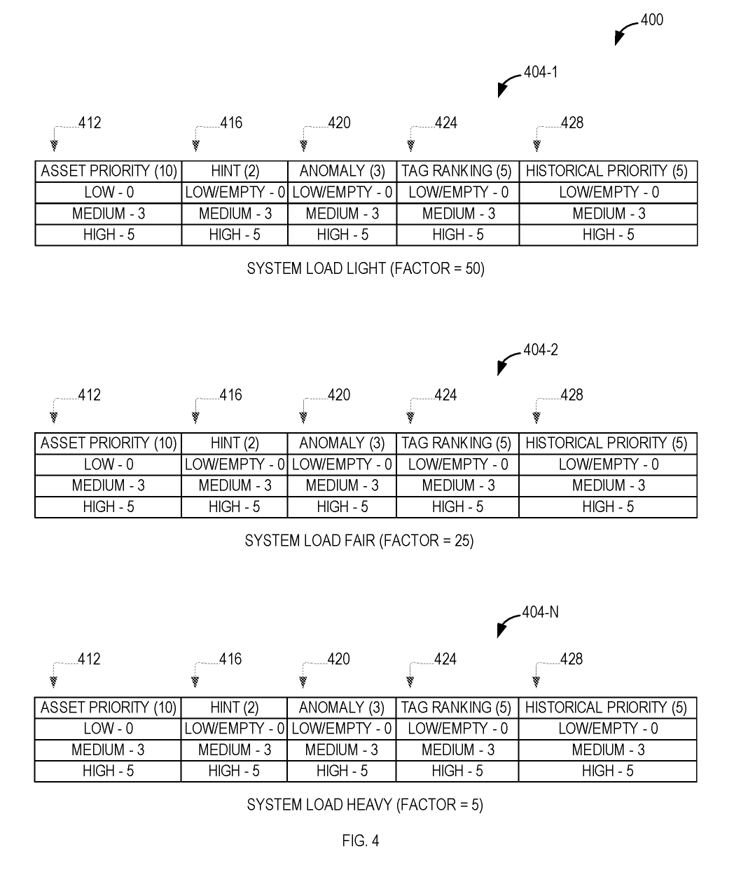

FIG. 4 is an example priority table 400 for determining a priority level for an incoming data container 300, in accordance with an example embodiment. The priority table 400 is divided into a plurality of load sections 404-1, . . . 404-N (collectively known as load sections 404). Each load section 404 corresponds to a particular system load, such as light, fair, heavy, and the like. In one example embodiment, the system load is characterized by a system utilization range, such as 0-25%, 26-50%, 51-75%, and 76-100%. The system load may be based on central processing unit (CPU) utilization, processing latencies, and the like.

Each column of the priority table 400 corresponds to a different criteria associated with a data container 300, and each criteria may be assigned a particular weight for calculating the priority level. For example, column 412 corresponds to the priority of an asset associated with the data container 300 and carries a weight of, for example, ten at high system loads and ten at medium system loads. The asset may be the asset that generated the data of the data container 300. The priority value is zero, three, or five depending on whether the asset priority is low, medium, or high, respectively.

Column 416 corresponds to a hint that indicates a suggested priority level for the data container 300. The hint may be provided by a user and may be obtained from metadata associated with the data container 300. As illustrated in the priority table 400, the hint may be ignored during high system loads by assigning a weight of zero. Column 420 corresponds to an anomaly associated with the data container 300 and carries a weight of, for example, three at all system loads. Anomalies may be detected using historical data, machine learning, and the like and may be used to increase the priority level of the data container 300. For example, if a sensor of an asset normally provides a sensor value of one, but provides a value of five in a particular data container 300, the change in value may be considered to be an anomaly and may be used to increase the priority level of the data container 300.

Column 424 corresponds to a tag ranking/query pattern associated with the data container 300 and carries a weight of, for example, five at high system loads. The relevance of the data container 300 to a query or pattern of queries submitted by a user may be determined and used to prioritize the data container 300. For example, if the data container 300 contains data from a wind turbine and the query is related to a wind turbine, the data container 300 may be assigned a high priority. Column 428 corresponds to historical information associated with the data container 300 and carries a weight of, for example, five at all system loads. For example, the priority level(s) determined for previously received data containers 300 associated with a particular asset type may be used to prioritize a newly received data container 300 associated with the same asset type. In this case, the data container 300 is weighted toward the priority level selected for the previously received data containers 300 associated with the same asset type.

Once a load section 404 is selected based on the current system load, the priority table 400 may be used to determine a priority level for an incoming data container 300 based on the criteria defined in priority table 400. Each defined criteria of a received data container 300 may be compared to the information of each row of the selected load section 404 to identify a row whose criteria matches that of the data container 300. The weight for each criteria, as defined in priority table 400, may be multiplied by the value of the corresponding criteria. The products for all applicable criteria may then be summed and the sum may be added to the factor assigned to the current system load level (such as a factor of fifty for a light system load, a factor of twenty-five for a fair system load, and a factor of five for a heavy system load).

For example, in the case of a heavy system load, load section 404-N is selected and the factor assigned to the current system load level is five. If the asset priority is medium, the hint level is high, the anomaly detection is low, the tag ranking is medium, and the historical data is high, the priority level is computed via the equation:

factor+asset priority+hint+anomaly+tag ranking+historical priority 5+(10*3)+(0*5)+(3*0)+(5*3)+(5*5)=5+30+0+0+15+25=75

Each priority queue is assigned a priority range and the data container 300 is appended to the priority queue having a range that includes the computed priority level, such as the priority level of 75.

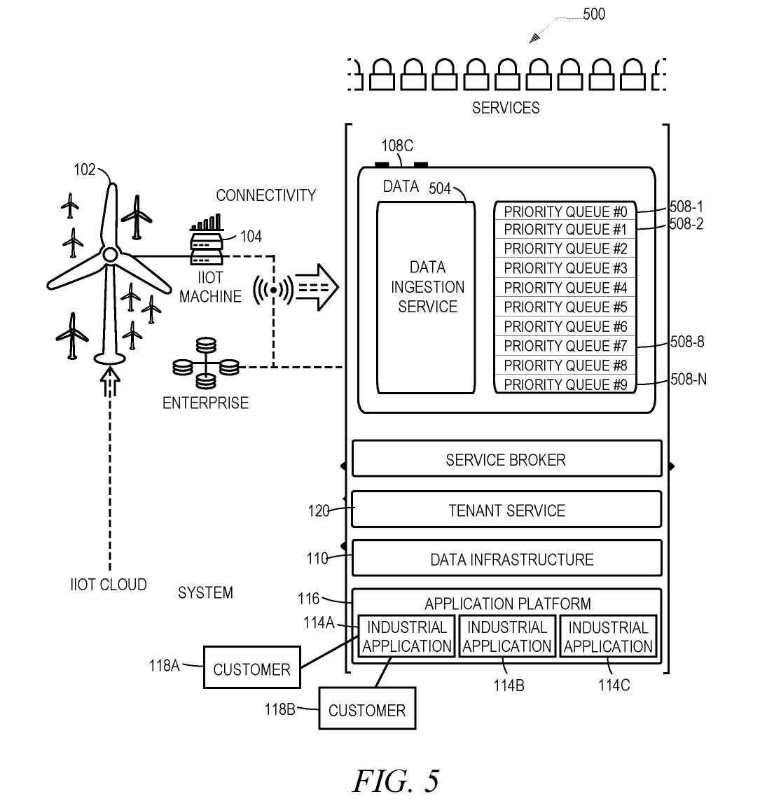

FIG. 5 is a block diagram of a portion of the example system 500 of FIG. 1 for ingesting and processing data containers 300, in accordance with an example embodiment. A data ingestion service 504 receives the data containers 300 and prioritizes each data container 300 based on the criteria of the priority table 400. Based on the determined priority level, each data container 300 is appended to one of a plurality of priority queues 508-1, . . . , 508-N (collectively known as priority queues 508 herein). Each priority queue 508 corresponds to a priority level or priority level range. For example, priority queue 508-1 corresponds to a priority range of 0-10, priority queue 508-2 corresponds to a priority range of 11-20, and priority queue 508-N corresponds to a priority range of 91-100. The priority level of 75 corresponds to priority queue 508-8. While ten priority queues 508 are shown in FIG. 5, any number of priority queues 508 may be utilized.

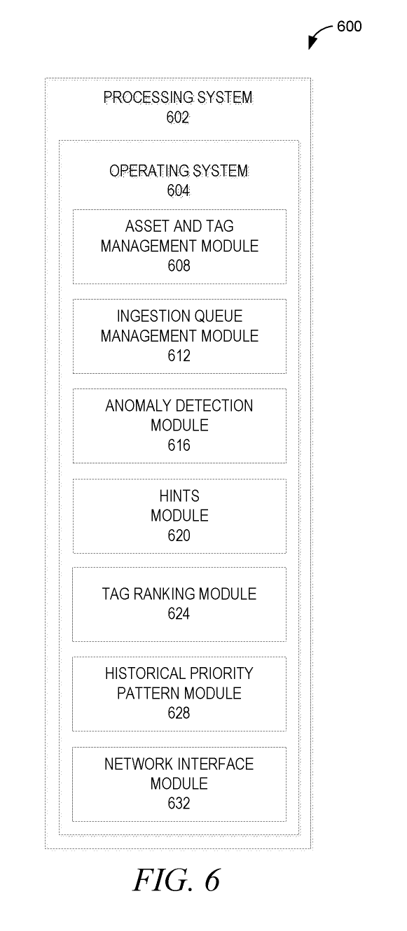

FIG. 6 is a block diagram of an example apparatus 600 for ingesting, prioritizing, and processing the data containers 300, in accordance with an example embodiment. For example, the apparatus 600 may be used to prioritize data containers 300 received by the system 100 and to assign a data container 300 to one of the priority queues 508.

The apparatus 600 is shown to include a processing system 602 that may be implemented on a server, client device, or other processing device that includes an operating system 604 for executing software instructions. In accordance with an example embodiment, the apparatus 600 may include an asset and tag management module 608, an ingestion queue management module 612, an anomaly detection module 616, a hints module 620, a tag ranking module 624, a historical priority pattern module 628, and a network interface module 632.

The asset and tag management module 608 enables a user to manage assets and the tags associated with the assets. In particular, the user may define a tag that indicates a priority of an asset, such as low, medium, or high. For example, a wind turbine may have hundreds of sensors; a user may use a tag to designate the sensors that measure the temperature of the rotors and the power output of the wind turbine as high priority since temperature affects both the performance of the wind turbine and the condition of the wind turbine.

The ingestion queue management module 610 prioritizes the received data containers 300 based on various criteria. The ingestion queue management module 610 computes the priority level based on the results generated by the anomaly detection module 616, the hints module 620, the tag ranking module 624, and the historical priority pattern module 628. The prioritization may be performed based on the asset type, a user designation or request (a hint), anomaly detection, user query patterns, the historical priority level of the data containers 300, and the like.

The anomaly detection module 616 analyzes the information of the data container 300 to determine if an anomaly exists. For example, the data values of the data container 300 can be compared to the historical values of similar data containers 300 in search of an anomaly. Anomalies may be detected using historical data, machine learning, and the like and may be used to affect the priority level of the data container 300, such as to increase the priority level of the data container 300. For example, if a sensor of an asset normally provides a sensor value of one, but provides a sensor value of five in a particular data container 300, the change in value may be considered an anomaly.

The hints module 620 processes the hints identified in, for example, the metadata associated with the received data container 300 to determine a hint value. A low value may be assigned to the hint value in the absence of a hint. The hint value may be set equal to the value assigned by a user or may be the value assigned by a user adjusted based on an adjustment factor. For example, the adjustment factor may be set to greater than one to increase the weight of the hint or less than one to decrease the weight of the hint.

The tag ranking module 624 determines the relevance of the data container 300 to a query or pattern of queries submitted by a user. As described above, the relevance of the data container 300 to a query or pattern of queries submitted by a user may be determined and used to prioritize the data container 300. For example, if the data container 300 is relevant to a query for utilization information from a wind turbine, the data container 300 may be assigned a high priority.

The historical priority pattern component 628 tracks the priority levels determined in the past for data containers 300 associated with each asset type and may be used to prioritize a newly received data container 300 based on the historical priority levels. In essence, the data container 300 is weighted toward the priority level selected for previously received data containers 300 associated with the same asset type by multiplying an indication of the historical priority level by the weight assigned to the historical priority pattern criteria.

The network interface module 632 provides an interface to the IIoT and enables the apparatus 600 to transmit and receive data containers 300 to/from the IIoT. The network may be based on wired communications, wireless communications, cellular communications, near field communications, Bluetooth® communications (e.g., Bluetooth® Low Energy), Wi-Fi® communications, and other communications. The network may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks.

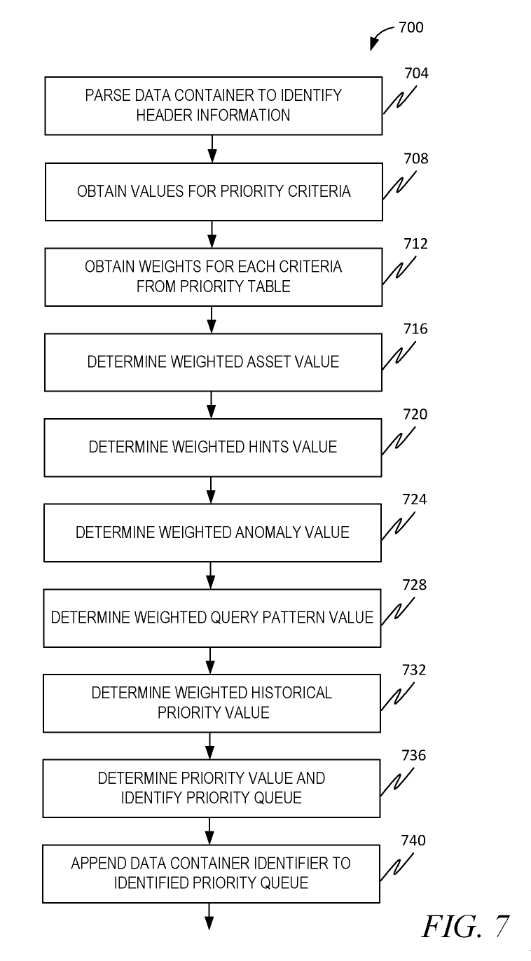

FIG. 7 is a flowchart for an example method 700 for prioritizing data to be ingested, in accordance with an example embodiment. In one example embodiment, one or more of the operations of the method 700 may be performed by the apparatus 600.

A data container 300 received by a component of the IIoT is parsed to identify the information in the header 304 (operation 704). The priority values corresponding to the data container 300, such as the priority of the asset(s) of the data container 300, the hint identified in the metadata associated with the received data container 300, the tag ranking/query pattern(s) associated with the data container 300, and the historical priority information corresponding to the data container 300 are obtained (operation 708). A lookup in the priority table 400 is performed based on the system load and the weights and priority values for each criteria associated with the data container 300 are obtained from the priority table 400 (operation 712).

The weighted asset priority value is determined (operation 716). For example, the ingestion queue management module 612 may multiply the weight assigned to the asset criteria by the asset priority value in the priority table 400 to determine the weighted asset priority value. The hints module 620 processes the hint identified in the metadata associated with the received data container 300 to determine a weighted hint value (operation 720). For example, the hints module 620 may multiply the weight assigned to the hints criteria by the hint value in the priority table 400 that corresponds to the hint in the metadata to determine the weighted hints value.

The information of the data container 300 is analyzed to determine if an anomaly is detected and a weighted anomaly value is determined (operation 724). The data content of the data container 300 can be compared to the historical values of the data content by the anomaly detection module 616 to determine if an anomaly exists. For example, the anomaly detection module 616 may multiply the weight assigned to the anomaly criteria by the anomaly value in the priority table 400 to determine the weighted anomaly value.

A query or pattern of queries submitted by a user are parsed to determine if the asset of the data container 300 is a subject of one of the queries (operation 728). For example, the query or pattern of queries may be analyzed by the tag ranking module 624 to determine the relevance (such as low, medium, or high) of the data container 300 to the query or pattern of queries. A data container 300 may be relevant if the asset of the data container 300 is a source of information needed to respond to the query. The tag ranking module 624 may multiply the weight assigned to the tag ranking/query pattern criteria by the query pattern value to determine the weighted query pattern value.

The query pattern value may be generated, for example, using a frequency of usage of different tags that occurs during the processing of queries. This may be performed across different users, different tenants, and the like. For example, queries may frequently identify a particular temperature sensor of a wind turbine; the query pattern value would then be based on the identity of the temperature sensor. In addition, the type of query may be used to determine the query pattern value. For example, if a particular tag is accessed frequently during the processing of a particular type of query (such as a query requesting the latest data or the data generated within the last hour), the query pattern value would be based on the identity of the particular tag, the particular type of query, or both.

The priority level(s) determined for previously received data containers 300 associated with the same asset type as a newly received data container 300 is/are determined and a weighted historical priority value is determined (operation 732). For example, if the data container 300 for a particular type of wind turbine was assigned a high priority level in the past, the historical priority value may be set to a high value. The weight assigned to the historical priority criteria is multiplied by the historical priority value to determine the weighted historical priority value.

The priority level and corresponding priority queue 408 are determined based on the obtained weighted values of each criteria and the system load factor (operation 736). For example, the weighted values of each criteria and the system load factor may be summed to determine a final priority value and the priority queue 408 corresponding to the final priority value may be identified. The data container 300, or an identifier of the data container 300, is then appended to the priority queue 408 that corresponds to the determined priority level (operation 740). The method 700 then ends.

### Modules, Components, and Logic

Certain embodiments are described herein as including logic or a number of components, modules, or mechanisms. Modules may constitute either software modules (e.g., code embodied on a machine-readable medium) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field-programmable gate array (FPGA) or an application specific integrated circuit (ASIC). A hardware module may also include programmable logic or circuitry that is temporarily configured by software to perform certain operations. For example, a hardware module may include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

### Machine and Software Architecture

The modules, methods, applications, and so forth described in conjunction with FIGS. 1-7 are implemented, in some embodiments, in the context of a machine and an associated software architecture. The sections below describe representative software architecture(s) and machine (e.g., hardware) architecture(s) that are suitable for use with the disclosed embodiments.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture may yield a smart device for use in the IoT, while yet another combination produces a server computer for use within a cloud computing architecture. Not all combinations of such software and hardware architectures are presented here, as those of skill in the art can readily understand how to implement the inventive subject matter in different contexts from the disclosure contained herein.

### Software Architecture

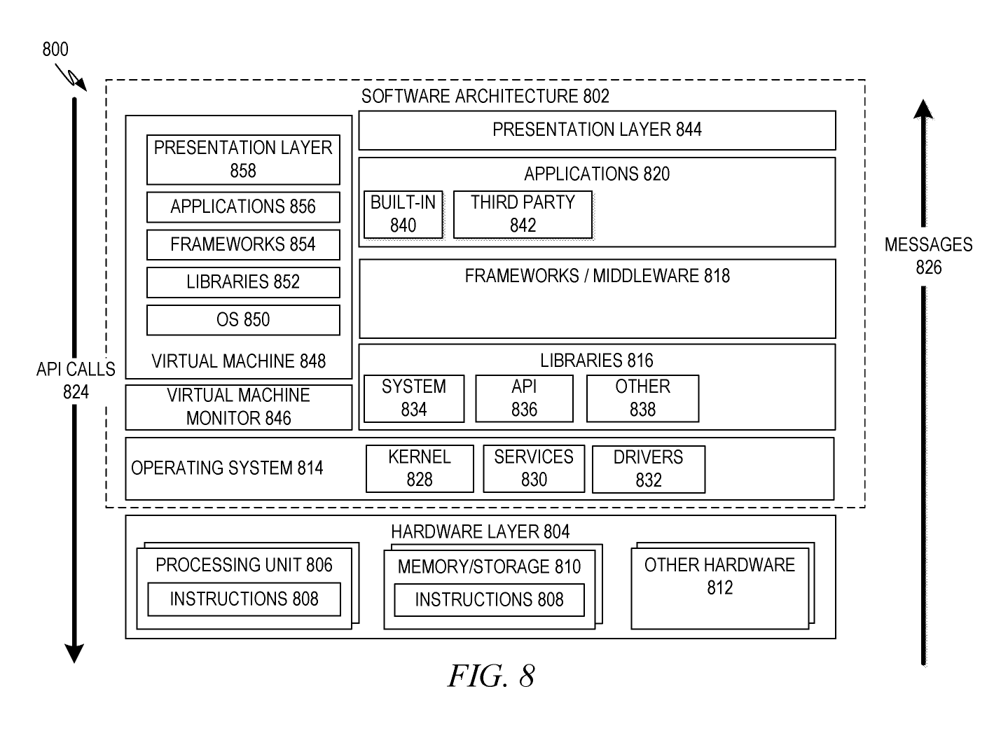

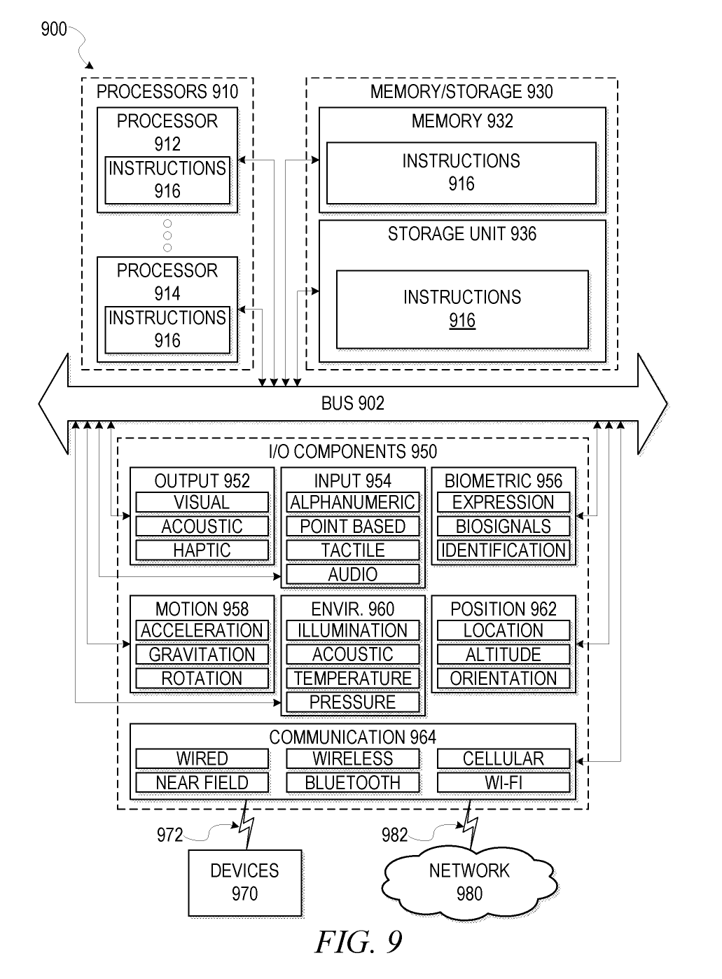

FIG. 8 is a block diagram 800 illustrating a representative software architecture 802, which may be used in conjunction with various hardware architectures herein described. FIG. 8 is merely a non-limiting example of a software architecture 802, and it will be appreciated that many other architectures may be implemented to facilitate the functionality described herein. The software architecture 802 may be executing on hardware such as a machine 900 of FIG. 9 that includes, among other things, processors 910, memory/storage 930, and input/output I/O components 950. A representative hardware layer 804 is illustrated and can represent, for example, the machine 900 of FIG. 9. The representative hardware layer 804 comprises one or more processing units 806 having associated executable instructions 808. The executable instructions 808 represent the executable instructions of the software architecture 802, including implementation of the methods, modules, and so forth of FIGS. 6-7. The hardware layer 804 also includes memory and/or storage modules 810, which also have the executable instructions 808. The hardware layer 804 may also comprise other hardware 812, which represents any other hardware of the hardware layer 904, such as the other hardware illustrated as part of the machine 900.

In the example architecture of FIG. 8, the software architecture 802 may be conceptualized as a stack of layers where each layer provides particular functionality. For example, the software architecture 802 may include layers such as an operating system 814, libraries 816, frameworks/middleware 818, applications 820, and a presentation layer 844. Operationally, the applications 820 and/or other components within the layers may invoke API calls 824 through the software stack and receive a response, returned values, and so forth illustrated as messages 826 in response to the API calls 824. The layers illustrated are representative in nature, and not all software architectures have all layers. For example, some mobile or special purpose operating systems may not provide a frameworks/middleware 818, while others may provide such a layer. Other software architectures may include additional or different layers.

The operating system 814 may manage hardware resources and provide common services. The operating system 814 may include, for example, a kernel 828, services 830, and drivers 832. The kernel 828 may act as an abstraction layer between the hardware and the other software layers. For example, the kernel 828 may be responsible for memory management, processor management (e.g., scheduling), component management, networking, security settings, and so on. The services 830 may provide other common services for the other software layers. The drivers 832 may be responsible for controlling or interfacing with the underlying hardware. For instance, the drivers 832 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth, depending on the hardware configuration.

The libraries 816 may provide a common infrastructure that may be utilized by the applications 820 and/or other components and/or layers. The libraries 816 typically provide functionality that allows other software modules to perform tasks in an easier fashion than to interface directly with the underlying operating system 814 functionality (e.g., kernel 828, services 830, and/or drivers 832). The libraries 816 may include system libraries 834 (e.g., C standard library) that may provide functions such as memory allocation functions, string manipulation functions, mathematic functions, and the like. In addition, the libraries 816 may include API libraries 836 such as media libraries (e.g., libraries to support presentation and manipulation of various media formats such as MPEG4, H.264, MP3, advanced audio coding (AAC), adaptive multi-rate (AMR), JPG, portable network graphics (PNG)), graphics libraries (e.g., an OpenGL framework that may be used to render two-dimensional and three-dimensional in a graphic context on a display), database libraries (e.g., SQLite that may provide various relational database functions), web libraries (e.g., WebKit that may provide web browsing functionality), and the like. The libraries 816 may also include a wide variety of other libraries 838 to provide many other APIs to the applications 820 and other software components/modules.

The frameworks/middleware 818 may provide a higher-level common infrastructure that may be utilized by the applications 820 and/or other software components/modules. For example, the frameworks/middleware 818 may provide various graphic user interface (GUI) functions, high-level resource management, high-level location services, and so forth. The frameworks/middleware 818 may provide a broad spectrum of other APIs that may be utilized by the applications 820 and/or other software components/modules, some of which may be specific to a particular operating system or platform.

The applications 820 include built-in applications 840 and/or third-party applications 842. Examples of representative built-in applications 840 may include, but are not limited to, a contacts application, a browser application, a book reader application, a location application, a media application, a messaging application, and/or a game application. Third-party applications 842 may include any of the built-in applications 840 as well as a broad assortment of other applications. In a specific example, the third-party application 842 (e.g., an application developed using the Android™ or iOS™ SDK by an entity other than the vendor of the particular platform) may be mobile software running on a mobile operating system such as iOS™, Android™ , Windows® Phone, or other mobile operating systems. In this example, the third-party application 842 may invoke the API calls 824 provided by the mobile operating system such as the operating system 814 to facilitate functionality described herein.

The applications 820 may utilize built-in operating system functions (e.g., kernel 828, services 830, and/or drivers 832), libraries (e.g., system libraries 834, API libraries 836, and other libraries 838), and frameworks/middleware 818 to create user interfaces to interact with users of the system. Alternatively, or additionally, in some systems, interactions with a user may occur through a presentation layer, such as the presentation layer 844. In these systems, the application/module “logic” can be separated from the aspects of the application/module that interact with a user.

Some software architectures utilize virtual machines. In the example of FIG. 8, this is illustrated by a virtual machine 848. A virtual machine creates a software environment where applications/modules can execute as if they were executing on a hardware machine (such as the machine 900 of FIG. 9, for example). The virtual machine 848 is hosted by a host operating system (operating system 814 in FIG. 8) and typically, although not always, has a virtual machine monitor 846, which manages the operation of the virtual machine 848 as well as the interface with the host operating system (i.e., operating system 814). A software architecture executes within the virtual machine 848, such as an operating system 850, libraries 852, frameworks/middleware 854, applications 856, and/or a presentation layer 858. These layers of software architecture executing within the virtual machine 848 can be the same as corresponding layers previously described or may be different.

### EXAMPLES

In one example embodiment, a data container is parsed to obtain header information; an asset type is identified based on the header information; a weighted asset priority value is determined based on a network-connected hardware-based asset associated with the data container; a second weighted priority value is determined; a priority level of the data container is determined based on the weighted asset priority value and the second weighted priority value; and an identifier of the data container is appended to a priority queue corresponding to the determined priority level, the priority queue implemented using a hardware-based data element.

In one example embodiment, the second weighted priority value is based on a user hint, a query pattern, a detected anomaly, a historical pattern of priority levels of similar data containers, or any combination thereof. In one example embodiment, the weighted asset priority value is determined by multiplying a weight assigned to an asset criteria by a priority value assigned to the asset associated with the data container. In one example embodiment, the priority level is determined by summing the weighted asset priority value and the second weighted priority value. In one example embodiment, the priority level is determined by summing the weighted asset priority value, the second weighted priority value, and a system load factor.

In one example embodiment, a system comprises one or more hardware processors; and memory to store instructions that, when executed by the one or more hardware processors perform operations comprising: parsing a data container to obtain header information; identifying an asset type based on the header information; determining a weighted asset priority value based on a network-connected hardware-based asset associated with the data container; determining a second weighted priority value; determining a priority level of the data container based on the weighted asset priority value and the second weighted priority value; and appending an identifier of the data container to a priority queue corresponding to the determined priority level, the priority queue implemented using a hardware-based data element.

In one example embodiment, a non-transitory machine-readable storage medium comprising instructions, which when implemented by one or more machines, cause the one or more machines to perform operations comprising: parsing, using at least one hardware processor, a data container to obtain header information; identifying, using the at least one hardware processor, an asset type based on the header information; determining, using the at least one hardware processor, a weighted asset priority value based on a network-connected hardware-based asset associated with the data container; determining, using the at least one hardware processor, a second weighted priority value; determining, using the at least one hardware processor, a priority level of the data container based on the weighted asset priority value and the second weighted priority value; and appending, using the at least one hardware processor, an identifier of the data container to a priority queue corresponding to the determined priority level, the priority queue implemented using a hardware-based data element.

### EXAMPLE MACHINE ARCHITECTURE AND MACHINE-READABLE MEDIUM

FIG. 9 is a block diagram illustrating components of a machine 900, according to some example embodiments, able to read instructions 916 from a machine-readable medium (e.g., a machine-readable storage medium) and perform any one or more of the methodologies discussed herein. Specifically, FIG. 9 shows a diagrammatic representation of the machine 900 in the example form of a computer system, within which the instructions 916 (e.g., software, a program, an application, an applet, an app, or other executable code) for causing the machine 900 to perform any one or more of the methodologies discussed herein may be executed. For example, the instructions 916 may cause the machine 900 to execute the flow diagrams of FIG. 7. Additionally, or alternatively, the instructions 916 may implement modules of FIG. 6, and so forth. The instructions 916 transform the general, non-programmed machine 900 into a particular machine programmed to carry out the described and illustrated functions in the manner described. In alternative embodiments, the machine 900 operates as a standalone device or may be coupled (e.g., networked) to other machines. In a networked deployment, the machine 900 may operate in the capacity of a server machine or a client machine in a server-client network environment, or as a peer machine in a peer-to-peer (or distributed) network environment. The machine 900 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 916, sequentially or otherwise, that specify actions to be taken by the machine 900. Further, while only a single machine 900 is illustrated, the term “machine” shall also be taken to include a collection of machines 900 that individually or jointly execute the instructions 916 to perform any one or more of the methodologies discussed herein.

The machine 900 may include processors 910, memory/storage 930, and I/O components 950, which may be configured to communicate with each other such as via a bus 902. In an example embodiment, the processors 910 (e.g., a CPU, a reduced instruction set computing (RISC) processor, a complex instruction set computing (CISC) processor, a graphics processing unit (GPU), a digital signal processor (DSP), an ASIC, a radio-frequency integrated circuit (RFIC), another processor, or any suitable combination thereof) may include, for example, a processor 912 and a processor 914 that may execute the instructions 916. The term “processor” is intended to include a multi-core processor 912, 914 that may comprise two or more independent processors 912, 914 (sometimes referred to as “cores”) that may execute the instructions 916 contemporaneously. Although FIG. 9 shows multiple processors 910, the machine 900 may include a single processor 912, 914 with a single core, a single processor 912, 914 with multiple cores (e.g., a multi-core processor 912, 914), multiple processors 912, 914 with a single core, multiple processors 912, 914 with multiples cores, or any combination thereof.

The memory/storage 930 may include a memory 932, such as a main memory, or other memory storage, and a storage unit 936, both accessible to the processors 910 such as via the bus 902. The storage unit 936 and memory 932 store the instructions 916 embodying any one or more of the methodologies or functions described herein. The instructions 916 may also reside, completely or partially, within the memory 932, within the storage unit 936, within at least one of the processors 910 (e.g., within the cache memory of processor 912, 914), or any suitable combination thereof, during execution thereof by the machine 900. Accordingly, the memory 932, the storage unit 936, and the memory of the processors 910 are examples of machine-readable media.

As used herein, “machine-readable medium” means a device able to store the instructions 916 and data temporarily or permanently and may include, but not be limited to, random-access memory (RAM), read-only memory (ROM), buffer memory, flash memory, optical media, magnetic media, cache memory, other types of storage (e.g., erasable programmable read-only memory (EEPROM)), and/or any suitable combination thereof. The term “machine-readable medium” should be taken to include a single medium or multiple media (e.g., a centralized or distributed database, or associated caches and servers) able to store the instructions 916. The term “machine-readable medium” shall also be taken to include any medium, or combination of multiple media, that is capable of storing instructions (e.g., instructions 916) for execution by a machine (e.g., machine 900), such that the instructions 916, when executed by one or more processors of the machine 900 (e.g., processors 910), cause the machine 900 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 950 may include a wide variety of components to receive input, provide output, produce output, transmit information, exchange information, capture measurements, and so on. The specific I/O components 950 that are included in a particular machine 900 will depend on the type of machine 900. For example, portable machines such as mobile phones will likely include a touch input device or other such input mechanisms, while a headless server machine will likely not include such a touch input device. It will be appreciated that the I/O components 950 may include many other components that are not shown in FIG. 9. The I/O components 950 are grouped according to functionality merely for simplifying the following discussion, and the grouping is in no way limiting. In various example embodiments, the I/O components 950 may include output components 952 and input components 854. The output components 952 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 954 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instruments), tactile input components (e.g., a physical button, a touch screen that provides location and/or force of touches or touch gestures, or other tactile input components), audio input components (e.g., a microphone), and the like.

In further example embodiments, the I/O components 950 may include biometric components 956, motion components 958, environmental components 960, or position components 962, among a wide array of other components. For example, the biometric components 956 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 958 may include acceleration sensor components (e.g., accelerometer), gravitation sensor components, rotation sensor components (e.g., gyroscope), and so forth. The environmental components 960 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 962 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 950 may include communication components 964 operable to couple the machine 900 to a network 980 or devices 970 via a coupling 982 and a coupling 972, respectively. For example, the communication components 964 may include a network interface component or other suitable device to interface with the network 980. In further examples, the communication components 964 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 970 may be another machine or any of a wide variety of peripheral devices (e.g., a peripheral device coupled via a USB).

Moreover, the communication components 964 may detect identifiers or include components operable to detect identifiers. For example, the communication components 964 may include radio frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 964, such as location via Internet Protocol (IP) geolocation, location via Wi-Fi® signal triangulation, location via detecting an NFC beacon signal that may indicate a particular location, and so forth.

### Transmission Medium

In various example embodiments, one or more portions of the network 980 may be an ad hoc network, an intranet, an extranet, a VPN, a LAN, a WLAN, a WAN, a WWAN, a MAN, the Internet, a portion of the Internet, a portion of the PSTN, a POTS network, a cellular telephone network, a wireless network, a Wi-Fi® network, another type of network, or a combination of two or more such networks. For example, the network 980 or a portion of the network 980 may include a wireless or cellular network and the coupling 982 may be a Code Division Multiple Access (CDMA) connection, a Global System for Mobile communications (GSM) connection, or another type of cellular or wireless coupling. In this example, the coupling 982 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 916 may be transmitted or received over the network 980 using a transmission medium via a network interface device (e.g., a network interface component included in the communication components 964) and utilizing any one of a number of well-known transfer protocols (e.g., hypertext transfer protocol (HTTP)). Similarly, the instructions 916 may be transmitted or received using a transmission medium via the coupling 972 (e.g., a peer-to-peer coupling) to the devices 970. The term “transmission medium” shall be taken to include any intangible medium that is capable of storing, encoding, or carrying the instructions 916 for execution by the machine 900, and includes digital or analog communications signals or other intangible media to facilitate communication of such software.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A method comprising:
parsing, using at least one hardware processor, a data container to obtain header information;
identifying, using the at least one hardware processor, an asset type based on the header information;
determining, using the at least one hardware processor, a weighted asset priority value based on a network-connected hardware-based asset associated with the data container;
determining, using the at least one hardware processor, a second weighted priority value;
determining, using the at least one hardware processor, a priority level of the data container based on the weighted asset priority value and the second weighted priority value; and
appending, using the at least one hardware processor, an identifier of the data container to a priority queue corresponding to the determined priority level, the priority queue implemented using a hardware-based data element.

2. The method of claim 1, wherein the second weighted priority value is based on a user hint.

3. The method of claim 1, wherein the second weighted priority value is based on a query pattern.

4. The method of claim 1, wherein the second weighted priority value is based on a detected anomaly.

5. The method of claim 1, wherein the second weighted priority value is based on a historical pattern of priority levels of similar data containers.

6. The method of claim 1, wherein the weighted asset priority value is determined by multiplying a weight assigned to an asset criteria by a priority value assigned to the asset associated with the data container.

7. The method of claim 1, wherein the priority level is determined by summing the weighted asset priority value and the second weighted priority value.

8. The method of claim 1, wherein the priority level is determined by summing the weighted asset priority value, the second weighted priority value, and a system load factor.

9. A system, the system comprising:
one or more hardware processors;
memory to store instructions that, when executed by the one or more hardware processors perform operations comprising:
parsing a data container to obtain header information;
identifying an asset type based on the header information;
determining a weighted asset priority value based on a network-connected hardware-based asset associated with the data container;
determining a second weighted priority value;
determining a priority level of the data container based on the weighted asset priority value and the second weighted priority value; and
appending an identifier of the data container to a priority queue corresponding to the determined priority level, the priority queue implemented using a hardware-based data element.

10. The system of claim 9, wherein the second weighted priority value is based on a user hint.

11. The system of claim 9, wherein the second weighted priority value is based on a query pattern.

12. The system of claim 9, wherein the second weighted priority value is based on a detected anomaly.

13. The system of claim 9, wherein the second weighted priority value is based on a historical pattern of priority levels of similar data containers.

14. The system of claim 9, wherein the weighted asset priority value is determined by multiplying a weight assigned to an asset criteria by a priority value assigned to the asset associated with the data container.

15. The system of claim 9, wherein the priority level is determined by summing the weighted asset priority value and the second weighted priority value.

16. The system of claim 9, wherein the priority level is determined by summing the weighted asset priority value, the second weighted priority value, and a system load factor.

17. A non-transitory machine-readable storage medium comprising instructions, which when implemented by one or more machines, cause the one or more machines to perform operations comprising:
parsing, using at least one hardware processor, a data container to obtain header information;
identifying, using the at least one hardware processor, an asset type based on the header information;
determining, using the at least one hardware processor, a weighted asset priority value based on a network-connected hardware-based asset associated with the data container;
determining, using the at least one hardware processor, a second weighted priority value;
determining, using the at least one hardware processor, a priority level of the data container based on the weighted asset priority value and the second weighted priority value; and
appending, using the at least one hardware processor, an identifier of the data container to a priority queue corresponding to the determined priority level, the priority queue implemented using a hardware-based data element.

18. The non-transitory machine-readable storage medium of claim 17, wherein the second weighted priority value is based on a user hint.

19. The non-transitory machine-readable storage medium of claim 17, wherein the second weighted priority value is based on a query pattern.

20. The non-transitory machine-readable storage medium of claim 17, wherein the second weighted priority value is based on a detected anomaly.
